(19) United States
(12) Patent Application Publication
(10) Pub. No.: US 2024/0427592 A1
(43) Pub. Date: Dec. 26, 2024

(54) DUAL SOFTWARE VERSION CAPABILITY THROUGH QUBIT STORAGE

(71) Applicant: Red Hat, Inc., Raleigh, NC (US)

(72) Inventors: Leigh Griffin, Waterford (IE); Christopher Foley, Waterford (IE)

(21) Appl. No.: 18/338,812

(22) Filed: Jun. 21, 2023

(51) Int. Cl. G06F 8/71

(52) U.S. Cl. CPC G06F 8/71

(57) ABSTRACT

A delta between a first version of a software application and a second version of the software application is determined, the delta including a plurality of delta binary values that identify a difference between the first version of the software application and the second version of the software application. A first plurality of qubits are encoded with a primary software application version that is one of the first version of the software application or the second version of the software application. Qubit metadata that refers to a second plurality of qubits is generated based on the delta, the second plurality of qubits including at least some of the first plurality of qubits The second version of the software application is generated from the first plurality of qubits, the second plurality of qubits and the qubit metadata.

### BACKGROUND

Quantum computing involves the use of quantum bits, referred to herein as “qubits,” which have characteristics that differ from those of classical (e.g., non-quantum) bits used in classical computing. For example, while a classical bit may be in a state of either one (1) or zero (0), a qubit may be in a “superposition” of both states simultaneously. A pair of qubits may also experience a physical phenomenon referred to as “entanglement,” in which the quantum state of each qubit may not be described independently of the state of the other qubit.

### SUMMARY

In one example a method is provided. The method includes determining, by a quantum computing system, a delta between a first version of a software application and a second version of the software application, the delta comprising a plurality of delta binary values that identify a difference between the first version of the software application and the second version of the software application. The method further includes encoding, by the quantum computing system, a first plurality of qubits with a primary software application version that comprises the first version of the software application or the second version of the software application. The method further includes generating, by the quantum computing system, qubit metadata that refers to a second plurality of qubits based on the delta, the second plurality of qubits including at least some of the first plurality of qubits. The method further includes generating, by the quantum computing system, the second version of the software application from the first plurality of qubits, the second plurality of qubits and the qubit metadata.

In another example a quantum computing system is provided. The quantum computing system includes a memory, and a processor device coupled to the memory. The processor device is to determine a delta between a first version of a software application and a second version of the software application, the delta comprising a plurality of delta binary values that identify a difference between the first version of the software application and the second version of the software application. The processor device is to further to encode a first plurality of qubits with a primary software application version that comprises the first version of the software application or the second version of the software application. The processor device is to generate qubit metadata that refers to a second plurality of qubits based on the delta, the second plurality of qubits including at least some of the first plurality of qubits. The processor device is to generate the second version of the software application from the first plurality of qubits, the second plurality of qubits and the qubit metadata.

In another example a non-transitory computer-readable storage medium system is provided. The non-transitory computer-readable storage medium includes executable instructions to cause a processor device of a quantum computing system to determine a delta between a first version of a software application and a second version of the software application, the delta comprising a plurality of delta binary values that identify a difference between the first version of the software application and the second version of the software application. The instructions further cause the processor device to encode a first plurality of qubits with a primary software application version that comprises the first version of the software application or the second version of the software application. The instructions further cause the processor device to generate qubit metadata that refers to a second plurality of qubits based on the delta, the second plurality of qubits including at least some of the first plurality of qubits. The instructions further cause the processor device to generate the second version of the software application from the first plurality of qubits, the second plurality of qubits and the qubit metadata.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which dual software version capability through qubit storage can be practiced according to some examples;

FIG. 2 is a flowchart of a method for implementing dual software version capability through qubit storage according to one example;

FIG. 3 is a simplified block diagram of the environment illustrated in FIG. 1; and

FIG. 4 is a block diagram of a quantum computing system suitable for implementing the examples disclosed herein.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Quantum computing is a rapidly evolving technology, and the number of qubits that can be implemented on a quantum computing system is increasing at a rapid pace. In addition, the length of time that a qubit can be maintained in a stable state is increasing.

A software application can include one or more files that collectively implement some desired functionality. The software manufacturer, over time, generates new versions of the software application to, for example, fix bugs and/or implement new features. Existing customers may request the new version of the software application at some point in time. New customers often have a choice between versions of a software application because the customer may not desire features implemented in a new version of software, or may prefer to wait until the new version of software has been used by other customers for a period of time to ensure the new version of software does not introduce new problems. Accordingly, it is common for a software manufacturer to have to maintain multiple versions of software.

The examples disclosed herein implement dual software version capability through qubit storage. The examples store values that correspond to two versions of a software application in a fewer number of qubits than the corresponding binary values, facilitating a smaller storage footprint than a classical computing system, and facilitating an ability to quickly generate either version of the software package upon request.

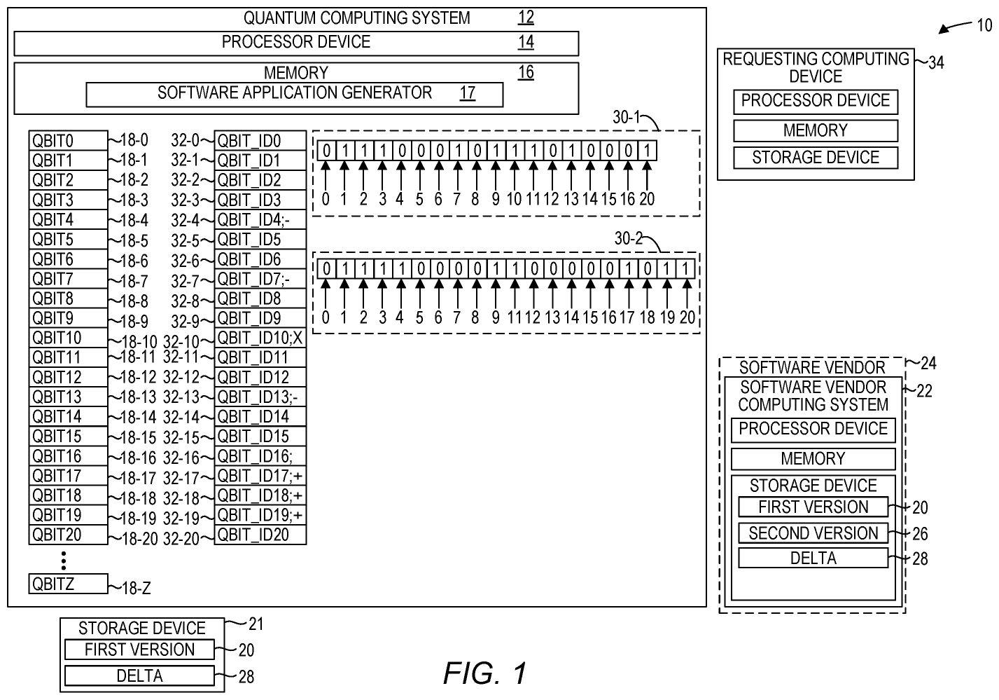

FIG. 1 is a block diagram of an environment 10 in which dual software version capability through qubit storage can be practiced according to some examples. The environment 10 includes a quantum computing system (QCS) 12 that includes a processor device 14 and a memory 16. A software application generator 17 executes in the memory 16. The QCS 12 implements a plurality of qubits 18-1-18-Z (generally, qubits 18). The number of qubits 18 may be hundreds, thousands or millions of qubits 18. The QCS 12 operates in a quantum environment but can operate using classical computing principles or quantum computing principles. When using quantum computing principles, the QCS 12 performs computations that utilize quantum-mechanical phenomena, such as superposition and entanglement. The QCS 12 may operate under certain environmental conditions, such as at or near 0° Kelvin. When using classical computing principles, the QCS 12 utilizes binary digits that have a value of either 1 or 0.

The software application generator 17 receives a first version 20 of a software package from a software vendor computing system 22 associated with a software vendor 24 and stores the first version 20 of the software package on a storage device 21. While, solely for purposes of illustration, the examples are described herein in terms of a software application package that comprises a plurality of files, the examples are not limited to any particular type of software application. The QCS 12 may be owned or operated by the software vendor 24 or may be a different entity responsible for distribution of the software packages of the software vendor 24. At a subsequent point in time the software vendor 24 generates a second version 26 of the software package. The second version 26 may add features and/or fix bugs in the first version 20. In one embodiment, the software vendor 24 generates a delta 28 that identifies the differences between the first version 20 and the second version 26. The differences may be additions to the primary version 20, modifications of the primary version 20, deletions to the primary version 20, or any combination thereof. The software application generator 17 receives the delta 28 from the software vendor computing system 22. In some embodiments, the software application generator 17 receives the second version 26 from the software vendor computing system 22 and generates the delta 28 based on a comparison of the first version 20 to the second version 26.

The software application generator 17, based on the delta 28, determines the binary value differences between the first version 20 and the second version 26. The term binary values, as used herein, refers to the set of values of 1 and 0. The software application generator 17 encodes a first plurality of the qubits 18 with a primary software package that is either the first version 20 or the second version 26. For purposes of illustration, it will be assumed that the primary software package is the first version 20. The software application generator 17 encodes a first plurality of the qubits 18 with the first version 20 by storing the binary values that compose the first version 20 into corresponding qubits 18. As an example, inset 30-1 identifies 17 binary values of the first version 20, “011100010111010001”. The software application generator 17 encodes these values into a first plurality of the qubits 18-0-18-16 and 18-20.

The software application generator 17 generates qubit metadata entries 32-0-32-16, and 32-20 that include qubit identifiers that identify the corresponding qubits 18-0-18-16 and 18-20 and the ordinal sequence that the values stored in the qubits 18-0-18-16 and 18-20 are to be concatenated to one another to derive the first version 20.

The software application generator 17, based on the delta 28, determines how to modify the binary values in the first plurality of qubits 18-0-18-16 and 18-20 to derive the second version 26. The modifications may include changing a value stored in a qubit 18-0-18-16 and 18-20, removing a value stored in a qubit 18-0-18-16 and 18-20, adding new values, or a combination of the above.

In this example, the software application generator 17, based on the delta 28 determines that certain values stored in the qubits 18-0-18-16 and 18-20 need to be changed, certain values stored in the qubits 18-0-18-16 and 18-20 need to be removed, and certain values need to be added (e.g., inserted at the appropriate locations).

The software application generator 17 generates qubit metadata that refers to a second plurality of the qubits 18, the second plurality of qubits 18 including at least some of the first plurality of qubits 18-0-18-16 and 18-20, to reflect the necessary modifications. In this example, the software application generator 17 determines that the binary values stored in the qubits 18-4, 18-7 and 18-13 need to be “flipped” to have the opposite binary value currently stored in such qubits 18-4, 18-7 and 18-13. The software application generator 17 generates qubit metadata by altering the qubit metadata entries 32-4, 32-7 and 32-13, to indicate that, in order to generate the second version 26, the values in the qubits 18-4, 18-7 and 18-13 need to be flipped. In this example, the software application generator 17 alters the qubit metadata entries 32-4, 32-7 and 32-13 by adding a predetermined character, “−”, to indicate the need to flip the values if the second version 26 is desired.

The software application generator 17 also determines that the binary value stored in the qubit 18-10 is to be removed to generate the second version 26. The software application generator 17 alters the qubit metadata entry 32-10 by adding a predetermined character, “X”, to indicate the need to remove this value from the first version 20 in order to generate the second version 26. The software application generator 17 also determines that three new values “101” need to be inserted in between the values stored in the qubit 18-16 and 18-20. The software application generator 17 stores the values “101” into corresponding qubits 18-17-18-19, and generates qubit metadata entries 32-17-32-19 that correspond to the qubits 18-17-18-19, and indicate that the values stored in the qubits 18-17-18-19 are to be inserted in between the values stored in the qubit 18-16 and the qubit 18-20 to generate the second version 26. In this example the software application generator 17 uses a predetermined character, “+”, to indicate that these values are added to the other values stored in the qubits 18 to generate the second version 26 but are not part of the first version 20. It is noted that the qubit metadata entries 32 may be generally referred to herein as qubit metadata.

The software application generator 17 may encode the binary values in the appropriate qubits 18 in accordance with the particular programming language being used. As an example, in one quantum programming language the following instruction may be used to encode a qubit 18 with a binary value of 1: qreg q[1];

Subsequently, the software application generator 17 receives a request for the second version 26 of the software package from a requesting computing device 34. The software application generator 17 accesses the qubit metadata entries 32 and processes the qubits 18-0-18-20 in accordance with the qubit metadata entries 32.

In particular, as illustrated in an inset 30-2, the software application generator 17 reads (e.g., measures) the values of the qubits 18-0-18-3 and stores the values encoded in the qubits 18-0-18-3. The software application generator 17 may measure the binary values encoded in the qubits 18 in accordance with the particular programming language being used. As an example, in one quantum programming language the following instruction may be used to measure the value of a qubit 18 and store the value in a classical register: measure q[0]->c[0].

The software application generator 17 reads the qubit 18-4 and based on the predetermined character “−” in the corresponding qubit metadata entry 32-4, causes the value read from the qubit 18-4 to be flipped. In some embodiments, prior to measuring the qubits 18, the software application generator 17 may execute an X gate on those qubits 18 that are to be flipped, such as, in this example, the qubits 18-4, 18-7, and 18-13, to cause the values stored in the qubits 18-4, 18-7, and 18-13 to be flipped. The software application generator 17 may then measure the qubits to obtain the appropriate value to derive the second version 26.

The software application generator 17 omits the value stored in the qubit 18-10 based on the predetermined character “X” in the qubit metadata entry 32-10. The software application generator 17 reads the qubits 18-17-18-19 and stores the values in between the values obtained from the qubits 18-16 and 18-20. After processing the qubits 18-0-10-20, the software application generator 17 has generated the values illustrated in the inset 30-2, which reflects the binary version of the second version 26. The software application generator 17 sends the values to the requesting computing device 34 as the second version 26.

It is noted that, because the software application generator 17 is a component of the QCS 12, functionality implemented by the software application generator 17 may be attributed to the QCS 12 generally. Moreover, in examples where the software application generator 17 comprises software instructions that program the processor device 14 to carry out functionality discussed herein, functionality implemented by the software application generator 17 may be attributed herein to the processor device 14.

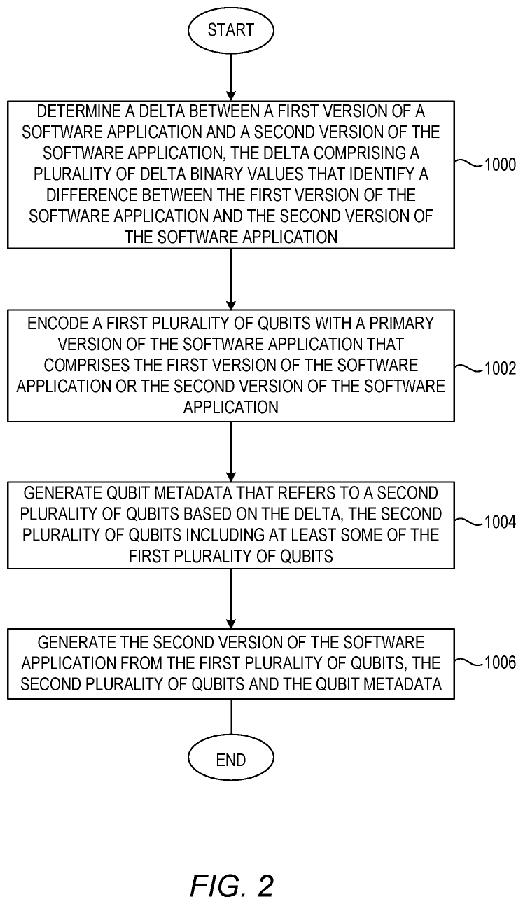

FIG. 2 is a flowchart of a method for implementing dual software version capability through qubit storage according to one example. FIG. 2 will be discussed in conjunction with FIG. 1. The QCS 12 determines the delta 28 between the first version 20 of the software application and the second version 26 of the software application, the delta comprising a plurality of delta binary values that identify a difference between the first version 20 of the software application and the second version 26 of the software application (block 1000). The QCS 12 encodes the first plurality of qubits 18-0-18-16 and 18-20 with a primary version of the software application that comprises the first version 20 of the software application or the second version 26 of the software application (block 1002). The QCS 12 generates the qubit metadata in the form of qubit metadata entries 32-4, 32-7, 32-10, 32-13, and 32-17-32-19 that refers to the second plurality of qubits 18-4, 18-7, 18-10, 18-13, and 18-17-18-19 based on the delta 28, the second plurality of qubits 18-4, 18-7, 18-10, 18-13, and 18-17-18-19 including at least some of the first plurality of qubits 18-0-18-16 and 18-20 (block 1004). The QCS 12 generates the second version 26 of the software application from the first plurality of qubits 18-0-18-16 and 18-20, the second plurality of qubits 18-4, 18-7, 18-10, 18-13, and 18-17-18-19 and the qubit metadata (block 1006).

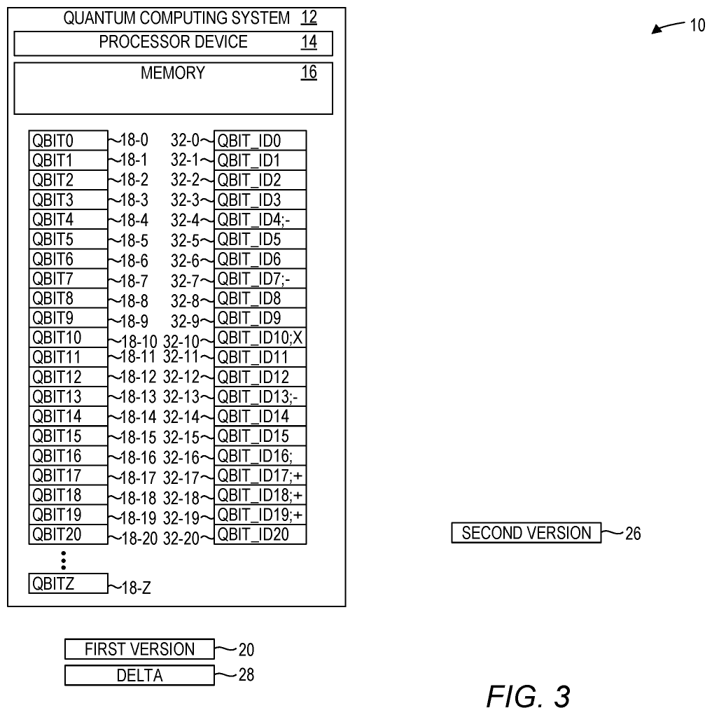

FIG. 3 is a simplified block diagram of the environment 10 illustrated in FIG. 1. In this example, the environment 10 includes the QCS 12, that in turn includes the processor device 14 and the memory 16. The processor device 14 is to determine the delta 28 between the first version 20 of the software package and the second version 26 of the software package, the delta comprising a plurality of delta binary values that identify a difference between the first version 20 of the software package and the second version 26 of the software package. The processor device 14 is to encode the first plurality of qubits 18-0-18-16 and 18-20 with a primary version of the software package that comprises the first version 20 of the software package or the second version 26 of the software package. The processor device 14 is to generate the qubit metadata in the form of qubit metadata entries 32-4, 32-7, 32-10, 32-13, and 32-17-32-19 that refers to the second plurality of qubits 18-4, 18-7, 18-10, 18-13, and 18-17-18-19 based on the delta 28, the second plurality of qubits 18-4, 18-7, 18-10, 18-13, and 18-17-18-19 including at least some of the first plurality of qubits 18-0-18-16 and 18-20. The processor device 14 is to generate the second version 26 of the software package from the first plurality of qubits 18-0-18-16 and 18-20, the second plurality of qubits 18-4, 18-7, 18-10, 18-13, and 18-17-18-19 and the qubit metadata.

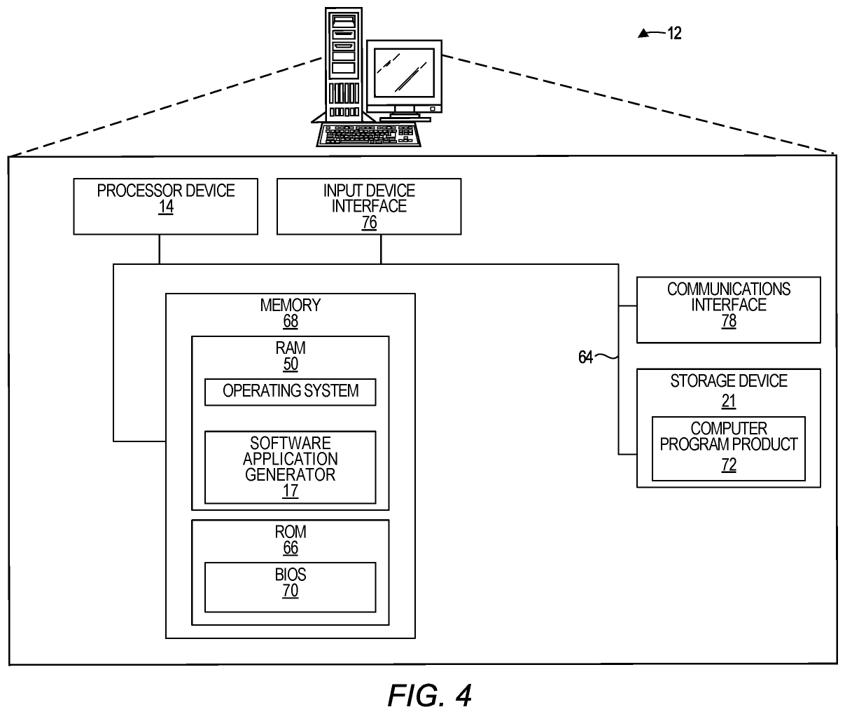

FIG. 4 is a block diagram of the QCS 12 suitable for implementing examples according to one example. The QCS 12 may comprise any computing or electronic device capable of including firmware, hardware, and/or executing software instructions to implement the functionality described herein, such as a computer server, a desktop computing device, a laptop computing device, a smartphone, a computing tablet, or the like. The QCS 12 includes the processor device 14, the system memory 16, and a system bus 64. The system bus 64 provides an interface for system components including, but not limited to, the system memory 16 and the processor device 14. The processor device 14 can be any commercially available or proprietary processor.

The system bus 64 may be any of several types of bus structures that may further interconnect to a memory bus (with or without a memory controller), a peripheral bus, and/or a local bus using any of a variety of commercially available bus architectures. The system memory 16 may include non-volatile memory 66 (e.g., read-only memory (ROM), erasable programmable read-only memory (EPROM), electrically erasable programmable read-only memory (EEPROM), etc.), and volatile memory 68 (e.g., random-access memory (RAM)). A basic input/output system (BIOS) 70 may be stored in the non-volatile memory 66 and can include the basic routines that help to transfer information between elements within the QCS 12. The volatile memory 68 may also include a high-speed RAM, such as static RAM, for caching data.

The QCS 12 may further include or be coupled to a non-transitory computer-readable storage medium such as the storage device 21, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 21 and other drives associated with computer-readable media and computer-usable media may provide non-volatile storage of data, data structures, computer-executable instructions, and the like.

A number of modules can be stored in the storage device 21 and in the volatile memory 68, including an operating system and one or more program modules, such as the software application generator 17, which may implement the functionality described herein in whole or in part. All or a portion of the examples may be implemented as a computer program product 72 stored on a transitory or non-transitory computer-usable or computer-readable storage medium, such as the storage device 21, which includes complex programming instructions, such as complex computer-readable program code, to cause the processor device 14 to carry out the steps described herein. Thus, the computer-readable program code can comprise software instructions for implementing the functionality of the examples described herein when executed on the processor device 14. The processor device 14, in conjunction with the software application generator 17 in the volatile memory 68, may serve as a controller, or control system, for the QCS 12 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 14 through an input device interface 76 that is coupled to the system bus 64 but can be connected by other interfaces such as a parallel port, an Institute of Electrical and Electronic Engineers (IEEE) 1394 serial port, a Universal Serial Bus (USB) port, an IR interface, and the like. The QCS 12 may also include a communications interface 78 suitable for communicating with a network as appropriate or desired.

Individuals will recognize improvements and modifications to the preferred examples of the disclosure. All such improvements and modifications are considered within the scope of the concepts disclosed herein and the claims that follow.

What is claimed is:

1. A method comprising:
determining, by a quantum computing system, a delta between a first version of a software application and a second version of the software application, the delta comprising a plurality of delta binary values that identify a difference between the first version of the software application and the second version of the software application;
encoding, by the quantum computing system, a first plurality of qubits with a primary software application version that comprises the first version of the software application or the second version of the software application;
generating, by the quantum computing system, qubit metadata that refers to a second plurality of qubits based on the delta, the second plurality of qubits including at least some of the first plurality of qubits; and
generating, by the quantum computing system, the second version of the software application from the first plurality of qubits, the second plurality of qubits and the qubit metadata.

2. The method of claim 1 wherein the primary software application version comprises the first version of the software application, and wherein the qubit metadata identifies a set of qubits in the first plurality of qubits that are not to be read to generate the second version of the software application.

3. The method of claim 1 wherein the primary software application version comprises the first version of the software application, and wherein the qubit metadata identifies a set of qubits in the first plurality of qubits wherein each respective qubit in the set of qubits is to have an opposite binary value to the binary value stored in the respective qubit to generate the second version of the software application.

4. The method of claim 3 further comprising:
applying, by the quantum computing system based on the qubit metadata, an operation to flip binary values stored in the set of qubits; and
subsequently reading, by the quantum computing system, each qubit in the set of qubits to obtain a corresponding binary value.

5. The method of claim 1 wherein the primary software application version comprises the first version of the software application, and wherein the qubit metadata identifies a set of qubits in the second plurality of qubits that are to be added to the first plurality of qubits in order to generate the second version of the software application.

6. The method of claim 1 further comprising:
receiving, by the quantum computing system from a requesting computing device, a request for the second version of the software application; and
wherein the second version of the software application is generated in response to receiving the request.

7. The method of claim 1 wherein the qubit metadata comprises qubit identifiers that identify each qubit in the first plurality of qubits and each qubit in the second plurality of qubits, and an ordinal sequence of each qubit in the first plurality of qubits and each qubit in the second plurality of qubits.

8. A quantum computing system, comprising:
a memory; and
a processor device coupled to the memory to:
determine a delta between a first version of a software application and a second version of the software application, the delta comprising a plurality of delta binary values that identify a difference between the first version of the software application and the second version of the software application;
encode a first plurality of qubits with a primary software application version that comprises the first version of the software application or the second version of the software application;
generate qubit metadata that refers to a second plurality of qubits based on the delta, the second plurality of qubits including at least some of the first plurality of qubits; and
generate the second version of the software application from the first plurality of qubits, the second plurality of qubits and the qubit metadata.

9. The quantum computing system of claim 8 wherein the primary software application version comprises the first version of the software application, and wherein the qubit metadata identifies a set of qubits in the first plurality of qubits that are not to be read to generate the second version of the software application.

10. The quantum computing system of claim 8 wherein the primary software application version comprises the first version of the software application, and wherein the qubit metadata identifies a set of qubits in the first plurality of qubits wherein each respective qubit in the set of qubits is to have an opposite binary value to the binary value stored in the respective qubit to generate the second version of the software application.

11. The quantum computing system of claim 10, wherein the processor device is further to:
apply, based on the qubit metadata, an operation to flip binary values stored in the set of qubits; and
subsequently read each qubit in the set of qubits to obtain a corresponding binary value.

12. The quantum computing system of claim 8 wherein the primary software application version comprises the first version of the software application, and wherein the qubit metadata identifies a set of qubits in the second plurality of qubits that are to be added to the first plurality of qubits in order to generate the second version of the software application.

13. The quantum computing system of claim 8, wherein the processor device is further to:
receive, from a requesting computing device, a request for the second version of the software application; and
wherein the second version of the software application is generated in response to receiving the request.

14. The quantum computing system of claim 8 wherein the qubit metadata comprises qubit identifiers that identify each qubit in the first plurality of qubits and each qubit in the second plurality of qubits, and an ordinal sequence of each qubit in the first plurality of qubits and each qubit in the second plurality of qubits.

15. A non-transitory computer-readable storage medium that includes executable instructions to cause a processor device of a quantum computing system to:
determine a delta between a first version of a software application and a second version of the software application, the delta comprising a plurality of delta binary values that identify a difference between the first version of the software application and the second version of the software application;
encode a first plurality of qubits with a primary software application version that comprises the first version of the software application or the second version of the software application;
generate qubit metadata that refers to a second plurality of qubits based on the delta, the second plurality of qubits including at least some of the first plurality of qubits; and
generate the second version of the software application from the first plurality of qubits, the second plurality of qubits and the qubit metadata.

16. The non-transitory computer-readable storage medium of claim 15 wherein the primary software application version comprises the first version of the software application, and wherein the qubit metadata identifies a set of qubits in the first plurality of qubits that are not to be read to generate the second version of the software application.

17. The non-transitory computer-readable storage medium of claim 15 wherein the primary software application version comprises the first version of the software application, and wherein the qubit metadata identifies a set of qubits in the first plurality of qubits wherein each respective qubit in the set of qubits is to have an opposite binary value to the binary value stored in the respective qubit to generate the second version of the software application.

18. The non-transitory computer-readable storage medium of claim 17, wherein the instructions further cause the processor device to:
apply, based on the qubit metadata, an operation to flip binary values stored in the set of qubits; and
subsequently read each qubit in the set of qubits to obtain a corresponding binary value.

19. The non-transitory computer-readable storage medium of claim 15 wherein the primary software application version comprises the first version of the software application, and wherein the qubit metadata identifies a set of qubits in the second plurality of qubits that are to be added to the first plurality of qubits in order to generate the second version of the software application.

20. The non-transitory computer-readable storage medium of claim 15, wherein the instructions further cause the processor device to:
receive, from a requesting computing device, a request for the second version of the software application; and
wherein the second version of the software application is generated in response to receiving the request.
